(19) United States
(12) Patent Application Publication
(10) Pub. No.: US 2026/0118810 A1
(43) Pub. Date: Apr. 30, 2026

(54) IMAGE FORMING APPARATUS PRINTING IMAGES ON LONG RECORDING SHEET

(71) Applicant: KYOCERA Document Solutions Inc., Osaka (JP)

(72) Inventor: Hiroki TAKEHANA, Osaka (JP)

(73) Assignee: KYOCERA Document Solutions Inc., Osaka (JP)

(21) Appl. No.: 19/365,789

(22) Filed: Oct. 22, 2025

(30) Foreign Application Priority Data
Oct. 25, 2024 (JP) 2024-188658

(51) Int. Cl. G03G 15/00

(52) U.S. Cl. CPC G03G 15/607; G03G 15/6508; G03G 15/6564; G03G 2215/00329; G03G 2215/00734

(57) ABSTRACT

An image forming apparatus includes a controller that executes a printing operation provided that a user permits, despite a recording sheet size indicated by size information (registered size) of a recording sheet placed on a manual bypass tray discording from a print size designated by a print job, and suspends the printing operation without permission from the user, when the recording sheet size indicated by size information (registered size) of the recording sheet stored in a long sheet feeding cassette discords from the print size designated by the print job.

### INCORPORATION BY REFERENCE

This application claims priority to Japanese Patent Application No. 2024-188658 filed on Oct. 25, 2024, the entire contents of which are incorporated by reference herein.

### BACKGROUND

The present disclosure relates to an image forming apparatus capable of printing images on a long recording sheet.

In recent years, there is an increasing demand for an image forming apparatus capable of printing on a long recording sheet, having a length in the sheet feeding direction longer than a predetermined length (e.g., A3 size). For such an image forming apparatus, a manual bypass tray, called a multipurpose (MP) tray, is generally employed to execute the printing on the long recording sheet.

### SUMMARY

The disclosure proposes further improvement of the foregoing technique.

In an aspect, the disclosure provides an image forming apparatus including a manual bypass tray, a long sheet feeding cassette, an image forming device, a transport device, a size storage device, an operation device, a control device, a first decider, and a second decider. The manual bypass tray is configured to receive a recording sheet having an unspecified length in a sheet feeding direction. The long sheet feeding cassette can be removably attached to the image forming apparatus, and is configured to receive a long recording sheet of up to a predetermined length. The image forming device forms an image on the recording sheet. The transport device transports the recording sheet placed on the manual bypass tray and the long sheet feeding cassette, to the image forming device. The size storage device stores therein manual size information indicating a size of the recording sheet placed on the manual bypass tray, and long size information indicating a size of the recording sheet stored in the long sheet feeding cassette. The operation device receives an input of an instruction from a user. The control device includes a processor, and acts as a controller, a first decider, and a second decider, when the processor executes a control program. The controller executes a printing operation according to a print job, including causing the transport device to transport the recording sheet from the manual bypass tray or the long sheet feeding cassette, to the image forming device, and causing the image forming device to form an image on the recording sheet. The first decider decides whether the recording sheet size indicated by the manual size information accords with a print size designated by the print job. The second decider decides whether the recording sheet size indicated by the long size information accords with the print size designated by the print job. When the first decider decides, in a case where the print size designated by the print job is longer than the recording sheet size indicated by the manual size information, and the recording sheet is transported from the manual bypass tray to the image forming device according to the print job, that the recording sheet size indicated by the manual size information discords from the print size designated by the print job, the controller executes the printing operation based on the print job, when an instruction to permit the printing operation is received by the operation device, and suspends the printing operation based on the print job, when an instruction to reject the printing operation is received by the operation device.

### BRIEF DESCRIPTION OF THE DRAWINGS

FIG. 1A to FIG. 1C are schematic front views each showing the appearance of an image forming apparatus according to an embodiment of the disclosure;

FIG. 2A and FIG. 2B are schematic front views each showing the appearance of the image forming apparatus according to the embodiment of the disclosure;

FIG. 3 is a functional block diagram schematically showing an essential internal configuration of the image forming apparatus according to the embodiment of the disclosure;

FIG. 4 is a flowchart showing an example of a size registration process of a long recording sheet, performed by the image forming apparatus;

FIG. 5A and FIG. 5B are schematic drawings each showing an example of an operation screen displayed on a display device;

FIG. 6 is a flowchart showing an example of a printing operation on the long recording sheet, performed by the image forming apparatus;

FIG. 7A and FIG. 7B are schematic drawings each showing an example of the operation screen displayed on the display device;

FIG. 8 is a flowchart showing another example of the printing operation on the long recording sheet, performed by the image forming apparatus;

FIG. 9 is a flowchart showing another example of the printing operation on the long recording sheet, performed by the image forming apparatus; and

FIG. 10 is a flowchart showing another example of the printing operation on the long recording sheet, performed by the image forming apparatus.

### DETAILED DESCRIPTION

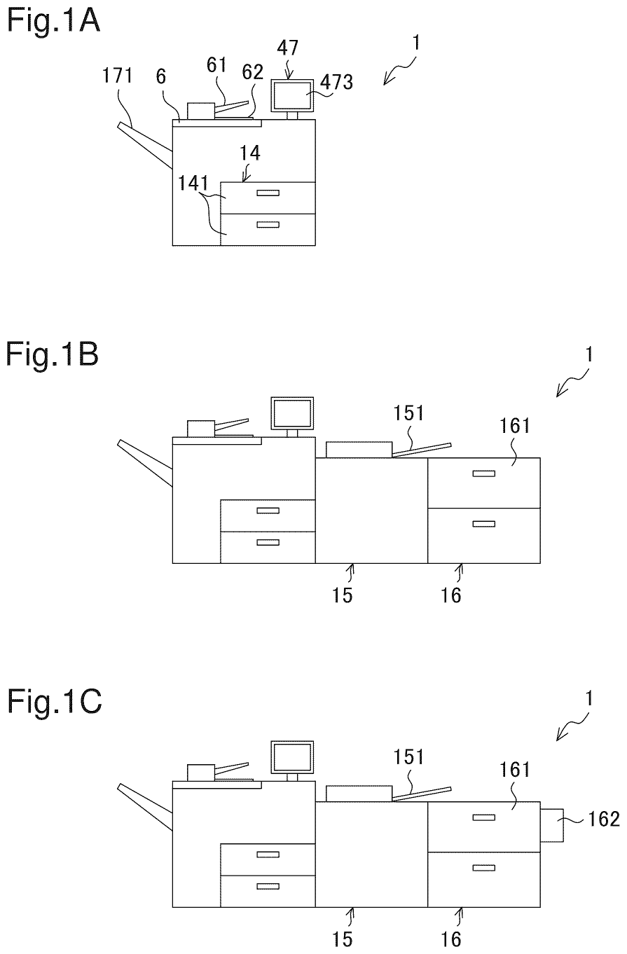

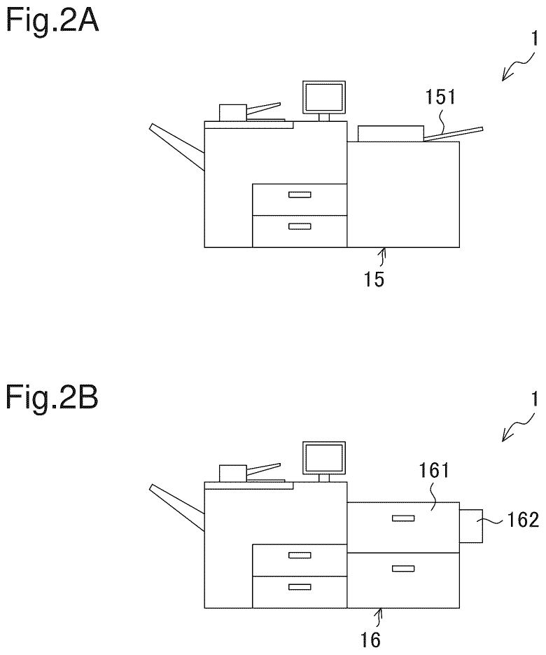

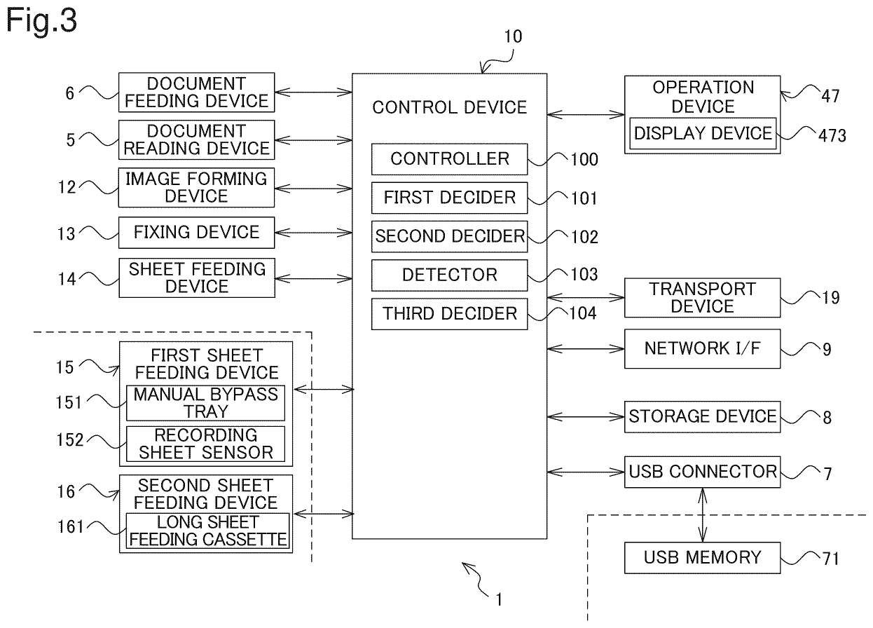

FIG. 1A to FIG. 1C, FIG. 2A, and FIG. 2B are schematic front views each showing the appearance of an image forming apparatus according to an embodiment of the disclosure. FIG. 3 is a functional block diagram schematically showing an essential internal configuration of the image forming apparatus according to the embodiment of the disclosure.

The image forming apparatus 1 is a multifunction peripheral having a plurality of functions, such as copying, printing, scanning, and facsimile transmission. The image forming apparatus 1 includes a control device 10, a document feeding device 6, a document reading device 5, an image forming device 12, a fixing device 13, a sheet feeding device 14, an operation device 47, a network interface (I/F) 9, and a storage device 8. The image forming apparatus 1 further includes a universal serial bus (USB) connector 7, to which a USB memory 71, which is an external storage medium, can be removably connected.

To the image forming apparatus 1, a first sheet feeding device 15, including a manual bypass tray 151 on which a long recording sheet can be placed, and a second sheet feeding device 16, including a long sheet feeding cassette 161 in which a long recording sheet can be stored, can be attached as optional devices, as shown in FIG. 1B and FIG. 1C. The manual bypass tray 151 is capable of receiving a recording sheet having a length of 1220 mm at maximum. The long sheet feeding cassette 161 is capable of receiving a recording sheet having a length of 700 mm at maximum, when s storage box 162 is drawn out from the side face, as shown in FIG. 1C.

The transport device 19 includes a transport route, along which the recording sheet placed on the manual bypass tray 151 and the long sheet feeding cassette 161 is guided to the image forming device 12, and transport rollers provided on the transport route to transport the recording sheet. The transport direction in which the transport device 19 transports the recording sheet is the same as the feeding direction of the recording sheet.

To the image forming apparatus 1, the first sheet feeding device 15 alone can be attached, without the second sheet feeding device 16 being attached, as shown in FIG. 2A. Likewise, the second sheet feeding device 16 alone can be attached to the image forming apparatus 1, without the first sheet feeding device 15 being attached, as shown in FIG. 2B.

The image forming apparatus 1 includes a connector for electrical connection with the first sheet feeding device 15, and a mounting mechanism via which the first sheet feeding device 15 can be removably attached. When the first sheet feeding device 15 is attached to the mounting mechanism, an electrical connection element of the first sheet feeding device 15 is inserted into the connector, so that electrical conduction is established between the electrical connection element and the connector. The connector is wire-connected to the control device 10, so that after the electrical conduction is established, the control device 10 and a controller (including a processor and so forth) of the first sheet feeding device 15 can communicate with each other. The second sheet feeding device 16 can also communicate with the control device 10, with a similar configuration.

The document feeding device 6 is openably connected to the upper face of the document reading device 5, for example via a non-illustrated hinge. The document feeding device 6 serves as a document retention cover, when a document placed on a non-illustrated platen glass is to be read. The document feeding device 6, generally called an automatic document feeder (ADF), includes a document tray 61 on which the document is placed, and a document discharge tray 62 provided on the lower side of the document tray 61. The document feeding device 6 feeds the documents placed on the document tray 61 one by one to the document reading device 5, and discharges the document to the document discharge tray 62.

The document reading device 5 includes a scanner, to read the document delivered from the document feeding device 6, or the document placed on the platen glass. The document reading device 5 can also sequentially read a plurality of documents delivered from the document feeding device 6.

To perform the document reading operation, the image forming apparatus 1 operates as follows. The document reading device 5 optically reads the image on the document delivered from the document feeding device 6 to the document reading device 5, or placed on the platen glass, and generates image data. The image data generated by the document reading device 5 is stored, for example, in a non-illustrated image memory.

To perform the image forming operation, the image forming apparatus 1 operates as follows. The image forming device 12 includes a photoconductor drum, a charging device, an exposure device, a developing device, and a primary transfer device for each of the colors, and forms an image on a recording sheet, serving as a recording medium, by secondary transfer via an intermediate transfer belt. The image forming device 12 forms an image on the recording sheet, delivered from one of the sheet feeding device 14, the first sheet feeding device 15, and the second sheet feeding device 16, thereby producing a printed material, on the basis of the image data generated through the document reading operation, image data stored in the image memory, or image data received from a computer connected via the network.

The fixing device 13 includes a heat roller, a pressure roller, and a drive mechanism therefor, and heats and presses the recording sheet on which the image has been formed by the image forming device 12, at the nip region defined between the mentioned rollers, to thereby fix the toner image onto the recording sheet. The recording sheet that has undergone the fixing process is delivered to an output tray 171.

The sheet feeding device 14 includes a sheet cassette 141, and also includes a pickup roller, transport rollers, a transport route, and rotational drive mechanism for the rollers, for picking up the recording sheet from the sheet cassette 141 and transporting the recording sheet to the image forming device 12. The first sheet feeding device 15 and the second sheet feeding device 16 also each include, like the sheet feeding device 14, the pickup roller, the transport rollers, the transport route, and the rotational drive mechanism for the rollers, which constitute the transport device 19 as a whole.

The first sheet feeding device 15 further includes a recording sheet sensor 152. The recording sheet sensor 152 is an optical sensor located downstream of the pickup roller in the sheet feeding direction, to detect the leading edge and the trailing edge of the recording sheet, and transmits a detection signal to the control device 10.

The operation device 47 includes various hard keys to be operated by the user, and receives the user's instructions inputted with the hard keys, to execute the functions and operations that the image forming apparatus 1 is configured to perform, for example the image forming operation.

The operation device 47 includes a display device 473 for displaying, for example, an operation guide for the user. The operation device 47 receives, through a touch panel provided on the display device 473, the user's instruction based on the touch operation performed by the user on the screen displayed on the display device 473.

The display device 473 includes, for example, a liquid crystal display (LCD). When the user touches a button or a key displayed on the screen, the touch panel receives the instruction corresponding to the touched position. In this case, the touch panel acts as a part of the operation device.

The network I/F 9 is a communication interface that transmits and receives various types of data to and from an external device (e.g., a personal computer) located inside the local area, or on the internet.

The storage device 8 is a large-capacity storage device such as a hard disk drive (HDD) and a solid-state drive (SSD), and contains various control programs.

The control device 10 includes a processor, a random-access memory (RAM), a read-only memory (ROM), and an exclusive hardware circuit. The processor is, for example, a central processing unit (CPU), an application specific integrated circuit (ASIC), or a micro processing unit (MPU). The control device 10 includes a controller 100, a first decider 101, a second decider 102, a detector 103, and a third decider 104.

To be more specific, the control device 10 acts as the controller 100, the first decider 101, the second decider 102, the detector 103, and the third decider 104, when the processor operates according to the control program stored in the storage device 8. Here, the controller 100 and other components may be constituted in the form of a hardware circuit, instead of being realized by the operation of the control device 10 according to the control program. This also applies to other embodiments, unless otherwise specifically noted.

The controller 100 serves to control the overall operation of the image forming apparatus 1. The controller 100 is connected to the document feeding device 6, the document reading device 5, the image forming device 12, the fixing device 13, the sheet feeding device 14, the operation device 47, the network I/F 9, the storage device 8, the USB connector 7, the first sheet feeding device 15, and the second sheet feeding device 16, and controls the operation of the mentioned components. The controller 100 also executes some processings required for the image forming operation to be performed by the image forming apparatus 1.

For example, the controller 100 executes a printing operation, including controlling the image forming device 12 so as to form an image on the recording sheet, according to a print job. The print job is, for example, transmitted from an external device such as a personal computer, via the network I/F 9, or acquired from an external storage medium such as the USB memory 71, via the USB connector 7.

The controller 100 stores manual size information about the recording sheet placed on the manual bypass tray 151, and long size information about the recording sheet stored in the long sheet feeding cassette, according to an instruction for designating the size, inputted to the operation device 47, in a built-in non-volatile memory in the control device 10, or in the storage device 8. The non-volatile memory and the storage device 8 exemplify the size storage device in the disclosure.

The first decider 101 decides whether the recording sheet size indicated by the manual size information accords with a print size designated by the print job.

The second decider 102 decides whether the recording sheet size indicated by the long size information accords with the print size designated by the print job.

When the first decider 101 decides, in the case where the print size designated by the print job is longer than the recording sheet size indicated by the manual size information, and the recording sheet is transported from the manual bypass tray 151 to the image forming device 12 according to the print job, that the recording sheet size indicated by the manual size information discords from the print size designated by the print job, the controller 100 executes the printing operation based on the print job, when an instruction to permit the printing operation is received by the operation device 47, and suspends the printing operation based on the print job, when an instruction to reject the printing operation is received by the operation device 47.

On the other hand, when the second decider 102 decides, in the case where the print size designated by the print job is longer than the recording sheet size indicated by the long size information, and the recording sheet is transported from the long sheet feeding cassette 161 to the image forming device 12 according to the print job, that the recording sheet size indicated by the long size information discords from the print size designated by the print job, the controller 100 suspends the printing operation based on the print job. In this case, the controller 100 can suspend the printing operation, without the need to receive an input of an instruction to reject the printing operation.

In addition, when both of the manual bypass tray 151 (first sheet feeding device 15) and the long sheet feeding cassette 161 (second sheet feeding device 16) are attached to the image forming apparatus 1, and when the print size designated by the print job is long, and the first decider 101 decides that the recording sheet size indicated by the size information of the recording sheet placed on the manual bypass tray 151 discords from the print size designated by the print job, and further, the second decider 102 decides that the recording sheet size indicated by the size information of the recording sheet stored in the long sheet feeding cassette 161 discords from the print size designated by the print job, the controller selects the recording sheet placed on the manual bypass tray 151, for the printing operation.

The detector 103 detects the length in the sheet feeding direction, of the recording sheet delivered from the manual bypass tray 151. The detector 103 measures the time after the leading edge of the recording sheet is detected and until the trailing edge thereof is detected, on the basis of detection signals transmitted from the recording sheet sensor 152, and detects, on the basis of the measured time and the sheet feeding speed (transport speed) of the recording sheet, the transport distance of the recording sheet, from the position of the leading edge of the recording sheet to the position of the trailing edge thereof, in other words the length of the recording sheet in the sheet feeding direction.

The third decider 104 decides whether the length of the recording sheet in the sheet feeding direction, detected by the detector 103, accords with the print size designated by the print job.

Further, in the case where the third decider 104 decides that the length of the recording sheet in the sheet feeding direction discords from the print size designated by the print job, the controller 100 executes the printing operation based on the print job, when the instruction to permit the printing operation is received by the operation device 47, but suspends the printing operation based on the print job, when the instruction to reject the printing operation is received by the operation device 47.

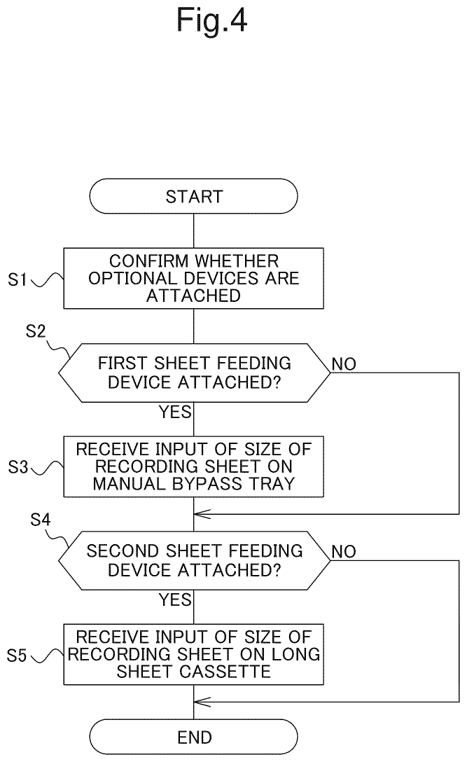

Referring now to a flowchart shown in FIG. 4, an example of a size registration process of the long recording sheet, performed by the image forming apparatus 1, will be described hereunder. This process is performed, for example, when the power to the image forming apparatus 1 is turned on.

The controller 100 decides whether the first sheet feeding device 15 and the second sheet feeding device 16, which are the optional devices, are attached to the image forming apparatus 1 (S1). The controller of each of the first sheet feeding device 15 and the second sheet feeding device 16 possesses a unique identification information, and transmits such identification information to the control device 10. The controller 100 decides that the first sheet feeding device 15 or the second sheet feeding device 16 is attached to the image forming apparatus 1, while receiving the identification information.

Upon deciding that the first sheet feeding device 15 is attached (YES at S2), the controller 100 receives the manual size information, indicating the size of the recording sheet placed on the manual bypass tray 151 of the first sheet feeding device 15, inputted by the user through the operation device 47, and stores the recording sheet size in the storage device 8 (S3). In contrast, upon deciding that the first sheet feeding device 15 is not attached (NO at S2), the controller 100 proceeds to S4.

Then the controller 100 decides whether the second sheet feeding device 16 is attached to the image forming apparatus 1 (S4). Upon deciding that the second sheet feeding device 16 is attached (YES at S4), the controller 100 receives the long size information, indicating the size of the recording sheet stored in the long sheet feeding cassette 161 of the second sheet feeding device 16, inputted by the user through the operation device 47, and stores the recording sheet size in the storage device 8 (S5). Thereafter, the registration process is finished.

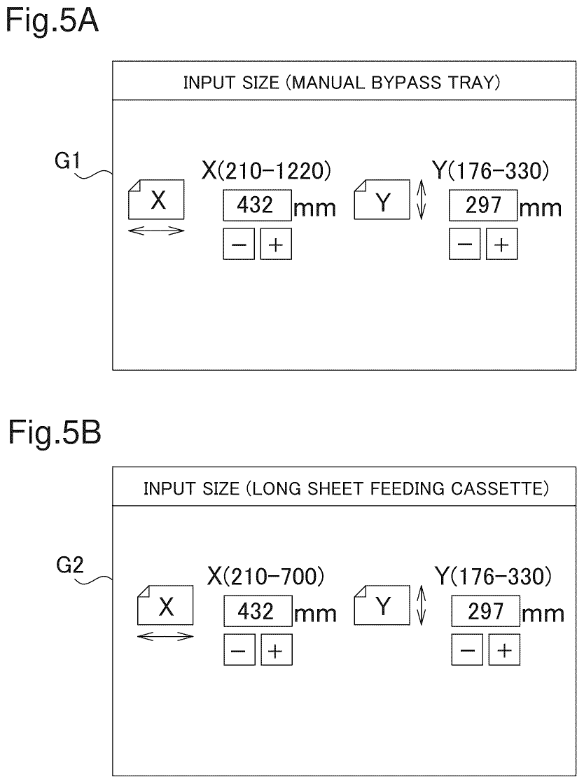

FIG. 5A illustrates an example of an operation screen for receiving the input of the manual size information, and FIG. 5B illustrates an example of an operation screen for receiving the input of the long size information. When the instruction to start inputting the recording sheet size is received by the operation device 47, the controller 100 causes the display device 473 to display the operation screen G1 shown in FIG. 5A, or the operation screen G2 shown in FIG. 5B. The operation device 47 receives the manual size information or the long size information, while the operation screen G1 or G2 is displayed.

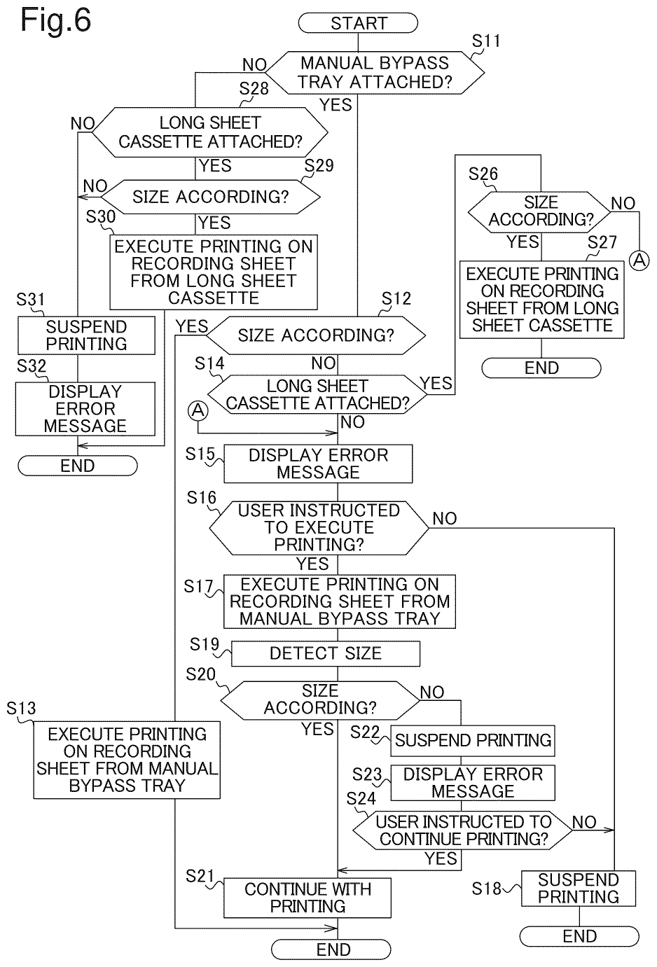

Referring now to a flowchart shown in FIG. 6, an example of the printing operation on the long recording sheet, performed by the image forming apparatus 1, will be described hereunder. This process is performed when the feeding source of the recording sheet is not designated by the user.

The controller 100 decides whether the manual bypass tray 151 (first sheet feeding device 15) is attached to the image forming apparatus 1 (S11). When the controller 100 decides that the manual bypass tray 151 is attached to the image forming apparatus 1 (YES at S11), the first decider 101 decides whether the recording sheet size, indicated by the size information about the recording sheet placed on the manual bypass tray 151, accords with the print size designated by the print job (S12).

When the first decider 101 decides that the size of the recording sheet on the manual bypass tray 151 accords with the print size (YES at S12), the controller 100 controls the operation of the first sheet feeding device 15 and the image forming device 12, thereby executing the printing operation, including causing the transport device 19 to transport the recording sheet from the manual bypass tray 151, and causing the image forming device 12 to form an image (S13). Thereafter, the printing operation is finished.

In contrast, when the first decider 101 decides that the size of the recording sheet on the manual bypass tray 151 discords from the print size (NO at S12), the controller 100 decides whether the long sheet feeding cassette 161 (second sheet feeding device 16) is attached to the image forming apparatus 1 (S14).

Upon deciding that the long sheet feeding cassette 161 is not attached to the image forming apparatus 1 (NO at S14), the controller 100 causes the display device 473 to display an error message notifying the user that the size of the recording sheet placed on the manual bypass tray 151 discords from the print size, and a message urging the user to input the instruction on whether to execute the printing operation, using the recording sheet currently placed on the manual bypass tray 151 (S15).

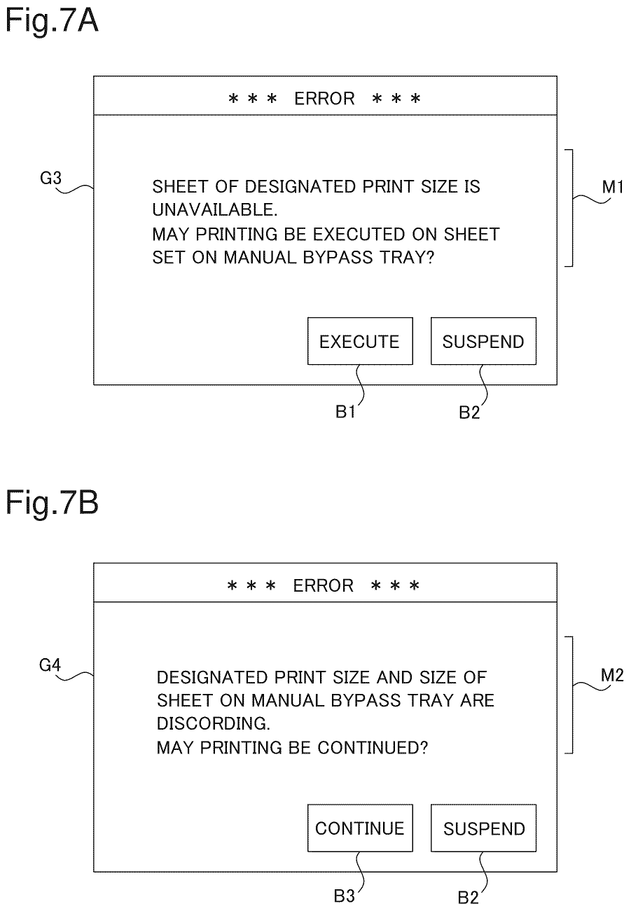

FIG. 7A illustrates an example of the operation screen displayed on the display device 473 in such a case. The operation screen G3 shown in FIG. 7A includes a message M1 describing the content of both of the above messages, an operation button B1 marked as “Execute”, and an operation button B2 marked as “Suspend”.

Upon receipt of the instruction not to execute the printing operation, inputted by a press of the operation button B2 by the user through the touch panel (NO at S16), the controller 100 suspends the printing operation (S18). Thereafter, the printing operation is finished.

In contrast, upon receipt of the instruction to execute the printing operation, inputted by a press of the operation button B1 by the user through the touch panel (YES at S16), the controller 100 controls the operation of the first sheet feeding device 15 and the image forming device 12, thereby executing the printing operation, including causing the transport device 19 to transport the recording sheet from the manual bypass tray 151, and causing the image forming device 12 to form an image (S17).

At this point, the detector 103 detects the length in the sheet feeding direction, of the recording sheet delivered from the manual bypass tray 151 (S19). The third decider 104 decides whether the length of the recording sheet in the sheet feeding direction, detected by the detector 103 accords with the print size designated by the print job (in other words, whether the actual size of the recording sheet placed on the manual bypass tray 151 accords with the print size) (S20).

When the third decider 104 decides that the actual size of the recording sheet placed on the manual bypass tray 151 accords with the print size (YES at S20), the controller 100 continues with the printing operation of the subsequent pages (recording sheets to be printed next, in the same print job) (S21). When the printing operation of all the remaining pages is finished, the process of FIG. 6 is finished.

In contrast, when the third decider 104 decides at S20 that the actual size of the recording sheet placed on the manual bypass tray 151 discords from the print size (NO at S20), the controller 100 suspends the printing operation (S22).

The controller 100 then causes the display device 473 to display an error message notifying the user that the size of the recording sheet delivered from the manual bypass tray 151 discords from the print size, and a message urging the user to input the instruction on whether to resume the printing operation, using the recording sheet placed on the manual bypass tray 151 (S23).

FIG. 7B illustrates an example of the operation screen displayed on the display device 473 in such a case. The operation screen G4 shown in FIG. 7B includes a message M2 describing the content of both of the above messages, an operation button B3 marked as “Continue”, and the operation button B2 marked as “Suspend”.

Upon receipt of the instruction not to execute the printing operation, inputted by a press of the operation button B2 by the user through the touch panel (NO at S24), the controller 100 suspends the printing operation (S18). Thereafter, the printing operation is finished.

In contrast, upon receipt of the instruction to continue with the printing operation, inputted by a press of the operation button B3 by the user through the touch panel (YES at S24), the controller 100 controls the operation of the first sheet feeding device 15 and the image forming device 12, thereby resuming and continuing with the printing operation, including causing the transport device 19 to transport the recording sheet from the manual bypass tray 151, and causing the image forming device 12 to form an image (S21). When the printing operation is finished thereafter, the process of FIG. 6 is finished.

As described above, when the first decider 101 decides at S12 that the size of the recording sheet on the manual bypass tray 151 discords from the print size (NO at S12), the controller 100 decides whether the long sheet feeding cassette 161 is attached to the image forming apparatus 1 (S14). When the controller 100 decides that the long sheet feeding cassette 161 is attached to the image forming apparatus 1 (YES at S14), the second decider 102 decides whether the recording sheet size, indicated by the size information about the recording sheet stored in the long sheet feeding cassette 161, accords with the print size designated by the print job (S26).

When the second decider 102 decides that the size of the recording sheet in the long sheet feeding cassette 161 accords with the print size (YES at S26), the controller 100 executes the printing operation, by causing the transport device 19 to transport the recording sheet from the second sheet feeding device 16, and causing the image forming device 12 to form an image (S27). Thereafter, the process of FIG. 6 is finished.

On the other hand, when the second decider 102 decides that the size of the recording sheet in the long sheet feeding cassette 161 discords from the print size (NO at S26), the controller 100 proceeds to S15. To be more specific, the controller 100 proceeds to the printing operation using the recording sheet placed on the manual bypass tray 151, instead of the recording sheet stored in the long sheet feeding cassette 161.

Now, upon deciding at S11 that the manual bypass tray 151 is not attached to the image forming apparatus 1 (NO at S11), the controller 100 decides whether the long sheet feeding cassette 161 (second sheet feeding device 16) is attached to the image forming apparatus 1 (S28). When the controller 100 decides that the long sheet feeding cassette 161 is attached to the image forming apparatus 1 (YES at S28), the second decider 102 decides whether the recording sheet size, indicated by the size information about the recording sheet stored in the long sheet feeding cassette 161, accords with the print size designated by the print job (S29).

When the second decider 102 decides that the size of the recording sheet in the long sheet feeding cassette 161 accords with the print size (YES at S29), the controller 100 executes the printing operation, by causing the transport device 19 to transport the recording sheet from the second sheet feeding device 16, and causing the image forming device 12 to form an image (S30). Thereafter, the process of FIG. 6 is finished.

In contrast, the controller 100 suspends the printing operation (S31), upon deciding that the long sheet feeding cassette 161 is not attached to the image forming apparatus 1 (NO at S28), or when the second decider 102 decides that the size of the recording sheet in the long sheet feeding cassette 161 discords from the print size (NO at S29). Then the controller 100 causes the display device 473 to display an error message, notifying the user that the recording sheet that accords with the print size is unavailable (S32). Thereafter, the process of FIG. 6 is finished.

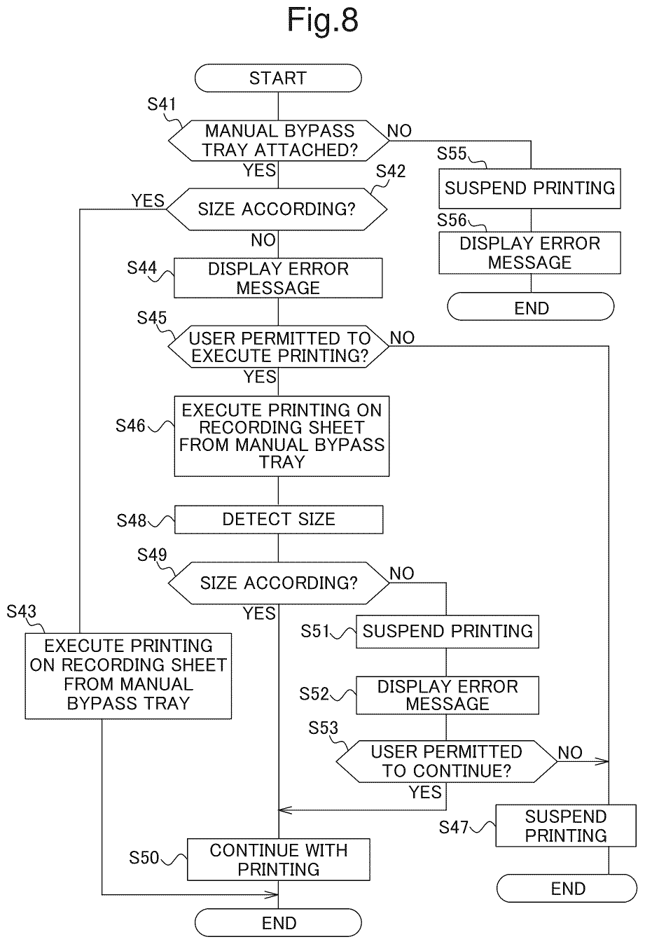

Referring now to a flowchart shown in FIG. 8, another embodiment of the printing operation on the long recording sheet, performed by the image forming apparatus 1, will be described hereunder. This operation is performed when the manual bypass tray 151 is designated by the user, as the feeding source of the recording sheet.

The controller 100 decides whether the manual bypass tray 151 (first sheet feeding device 15) is attached to the image forming apparatus 1 (S41). When the controller 100 decides that the manual bypass tray 151 is attached to the image forming apparatus 1 (YES at S41), the first decider 101 decides whether the recording sheet size, indicated by the size information about the recording sheet placed on the manual bypass tray 151, accords with the print size designated by the print job (S42).

When the first decider 101 decides that the size of the recording sheet on the manual bypass tray 151 accords with the print size (YES at S42), the controller 100 controls the operation of the first sheet feeding device 15 and the image forming device 12, thereby executing the printing operation, including causing the transport device 19 to transport the recording sheet from the manual bypass tray 151, and causing the image forming device 12 to form an image (S43). Thereafter, the process of FIG. 8 is finished.

In contrast, when the first decider 101 decides that the size of the recording sheet on the manual bypass tray 151 discords from the print size (NO at S42), the controller 100 proceeds to S44 to S54. Here, the operation of S44 to S54 is the same as that of S15 to S25 shown in FIG. 6, and therefore the description will not be repeated.

In the case of deciding at S41 that the manual bypass tray 151 is not attached to the image forming apparatus 1 (NO at S41), the controller 100 suspends the printing operation (S55). The controller 100 then causes the display device 473 to display an error message notifying the user that the recording sheet of the size that accords with the print size is not placed on the manual bypass tray 51 (S56). Thereafter, the process of FIG. 8 is finished.

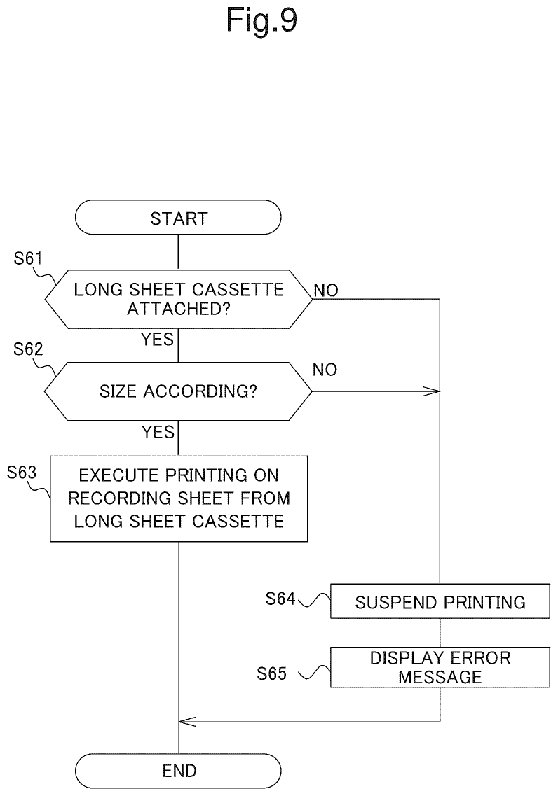

Referring to a flowchart shown in FIG. 9, still another embodiment of the printing operation on the long recording sheet, performed by the image forming apparatus 1, will be described hereunder. This operation is performed when the long sheet feeding cassette 161 is designated by the user, as the feeding source of the recording sheet.

The controller 100 decides whether the long sheet feeding cassette 161 (second sheet feeding device 16) is attached to the image forming apparatus 1 (S61). When the controller 100 decides that the long sheet feeding cassette 161 is attached to the image forming apparatus 1 (YES at S61), the second decider 102 decides whether the recording sheet size, indicated by the size information about the recording sheet stored in the long sheet feeding cassette 161, accords with the print size designated by the print job (S62).

When the second decider 102 decides that the size of the recording sheet in the long sheet feeding cassette 161 accords with the print size (YES at S62), the controller 100 executes the printing operation, by causing the transport device 19 to transport the recording sheet from the second sheet feeding device 16, and causing the image forming device 12 to form an image (S63). Thereafter, the process of FIG. 9 is finished.

In contrast, the controller 100 suspends the printing operation (S64), upon deciding that the long sheet feeding cassette 161 is not attached to the image forming apparatus 1 (NO at S61), or when the second decider 102 decides that the size of the recording sheet in the long sheet feeding cassette 161 discords from the print size (NO at S62). Then the controller 100 causes the display device 473 to display an error message, notifying the user that the recording sheet that accords with the print size is not stored in the long sheet feeding cassette 61 (S65). Thereafter, the process of FIG. 9 is finished.

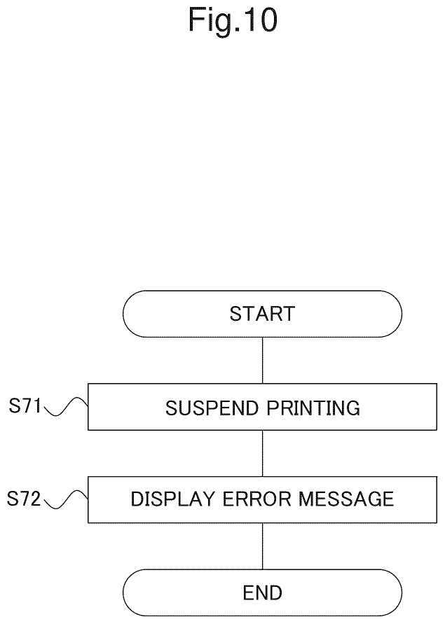

Referring to a flowchart shown in FIG. 10, an example of a process related to the printing operation on the long recording sheet, to be performed by the image forming apparatus 1, will be described hereunder. This operation is performed when a device other than the manual bypass tray 151 and the long sheet feeding cassette 161 is designated by the user, as the feeding source of the recording sheet.

Since it is impossible to set the long recording sheet on a device other than the manual bypass tray 151 and the long sheet feeding cassette 161, the controller 100 suspends the printing operation (S71), and controls the display device 473 so as to display an error message, notifying the user that the recording sheet of the size that accords with the print size is unavailable (S72). Thereafter, the process of FIG. 10 is finished.

According to the embodiment described above, the printing operation is executed, provided that the user permits (i.e., that the instruction to execute the printing operation is received), despite the recording sheet size (registered size) indicated by the size information about the recording sheet placed on the manual bypass tray 151 discording from the print size designated by the print job. Therefore, even though the actual size of the recording sheet placed on the manual bypass tray 151 discords from the recording sheet size indicated by the manual size information stored in the storage device 8, the printing operation on the long recording sheet can be surely executed through a simple operation, according to the intention of the user, provided that the size of the recording sheet on the manual bypass tray 151 accords with the print size designated by the print job. On the other hand, when the recording sheet size, indicated by the size information about the recording sheet in the long sheet feeding cassette 161, discords from the print size designated by the print job, the printing operation is suspended, without waiting for an instruction from the user.

In the case where neither the recording sheet size indicated by the manual size information, nor the recording sheet size indicated by the long size information accord with the print size, the recording sheet placed on the manual bypass tray 151 is adopted for the printing operation.

According to the foregoing embodiment, as described above, the advantage of the manual bypass tray 151, that the recording sheet size can be easily changed simply by replacing the recording sheet to be placed thereon, can be fully utilized. Therefore, with the image forming apparatus 1, to which the manual bypass tray 151 that can receive the long recording sheet, and the long sheet feeding cassette 161 that can receive the long recording sheet, can both be attached, the printing operation on the long recording can be surely executed, through a simple operation.

In the case of existing image forming apparatuses, unlike the one according to the foregoing embodiment, a mismatch may occur, such that the print size designated by the print job and the size of the recording sheet delivered from the manual bypass tray discord from each other. Although some techniques to cope with such a mismatch have been proposed, those techniques are not applicable to the printing operation on the long recording sheet.

Long sheet feeding cassettes, capable of receiving the long recording sheet, have been proposed, and some of them are already put to practical use. Accordingly, adopting both of the manual bypass tray and the long sheet feeding cassette enables the printing operation on the long recording sheet to be more effectively performed. For example, the manual bypass tray provides a higher degree of freedom in the length of the recording sheet to be placed thereon, compared with the long sheet feeding cassette, because the restriction on the length of the recording sheet in the transport direction is less strict, than the case of the long sheet feeding cassette.

Now, the long recording sheet is classified as a non-standard size, not the standard size. Accordingly, the user has to register the size of the long recording sheet set on the manual bypass tray or the long sheet feeding cassette, by manually inputting the size. In other words, although it is easy for the user to place a long recording sheet of a different size on the manual bypass tray, the user has to perform the manual operation, to register the size of the long recording sheet to be newly set.

Accordingly, there may arise the case where, while the long recording sheet of a different size has been placed on the manual bypass tray, the size of such long recording sheet has not been registered. In other words, the discordance between the actual size of the recording sheet placed on the manual bypass tray, and the registered size, may be incurred. Such a situation makes it difficult to properly execute the printing operation on the long recording sheet.

According to the foregoing embodiment, in contrast, with the image forming apparatus 1, to which the manual bypass tray that can receive the long recording sheet, and the long sheet feeding cassette that can receive the long recording sheet, can both be attached, the printing operation on the long recording can be surely executed, through a simple operation.

The disclosure may be modified in various manners, without limitation to the foregoing embodiment. Further, the configurations and processings according to the embodiment, described with reference to FIG. 1 to FIG. 10, are merely exemplary, and in no way intended to limit the disclosure to those configurations and processings.

While the present disclosure has been described in detail with reference to the embodiments thereof, it would be apparent to those skilled in the art that various changes and modifications may be made therein within the scope defined by the appended claims.

What is claimed is:

1. An image forming apparatus comprising:
a manual bypass tray configured to receive a recording sheet having an unspecified length in a sheet feeding direction;
a long sheet feeding cassette removably attached to the image forming apparatus, and configured to receive a long recording sheet of up to a predetermined length;
an image forming device that forms an image on the recording sheet;
a transport device that transports the recording sheet placed on the manual bypass tray and the long sheet feeding cassette, to the image forming device;
a size storage device that stores therein manual size information indicating a size of the recording sheet placed on the manual bypass tray, and long size information indicating a size of the recording sheet stored in the long sheet feeding cassette;
an operation device that receives an input of an instruction from a user; and
a control device including a processor, and configured to act, when the processor executes a control program, as:
a controller that executes a printing operation according to a print job, including causing the transport device to transport the recording sheet from the manual bypass tray or the long sheet feeding cassette, to the image forming device, and causing the image forming device to form an image on the recording sheet;
a first decider that decides whether the recording sheet size indicated by the manual size information accords with a print size designated by the print job; and
a second decider that decides whether the recording sheet size indicated by the long size information accords with the print size designated by the print job,
wherein, when the first decider decides, in a case where the print size designated by the print job is longer than the recording sheet size indicated by the manual size information, and the recording sheet is transported from the manual bypass tray to the image forming device, that the recording sheet size indicated by the manual size information discords from the print size designated by the print job, the controller executes the printing operation based on the print job, when an instruction to permit the printing operation is received by the operation device, and suspends the printing operation based on the print job, when an instruction to reject the printing operation is received by the operation device.

2. The image forming apparatus according to claim 1,
wherein the controller suspends the printing operation based on the print job, when the second decider decides, in the case where the print size designated by the print job is longer than the recording sheet size indicated by the long size information, and the recording sheet is transported from the long sheet feeding cassette to the image forming device according to the print job, that the recording sheet size indicated by the long size information discords from the print size designated by the print job.

3. The image forming apparatus according to claim 1, further comprising:
a detector that detects a length in the sheet feeding direction, of the recording sheet delivered from the manual bypass tray;
wherein, when the processor executes the control program, the control device further configured to act as a third decider that decides whether the length of the recording sheet in the sheet feeding direction, detected by the detector, accords with the print size designated by the print job,
wherein, when the third decider decides that the length of the recording sheet in the sheet feeding direction discords from the print size designated by the print job,
the controller executes printing operation based on the print job, when an instruction to permit the printing operation is received by the operation device, and suspends the printing operation based on the print job, when an instruction not to permit the printing operation is received by the operation device.

4. The image forming apparatus according to claim 1,
wherein, when the manual bypass tray and the long sheet feeding cassette are both attached to the image forming apparatus, and the print size designated by the print job is the long size, and
when the first decider decides that the recording sheet size, indicated by the size information about the recording sheet placed on the manual bypass tray, discords from the print size designated by the print job, and further, when the second decider decides that the recording sheet size, indicated by the size information about the recording sheet stored in the long sheet feeding cassette, discords from the print size designated by the print job,
the controller executes the printing operation, using the recording sheet placed on the manual bypass tray.

5. The image forming apparatus according to claim 1,
wherein, when the manual bypass tray and the long sheet feeding cassette are both attached to the image forming apparatus, and the print size designated by the print job is the long size, and
when the first decider decides that the recording sheet size, indicated by the size information about the recording sheet placed on the manual bypass tray, discords from the print size designated by the print job, and further, when the second decider decides that the recording sheet size, indicated by the size information about the recording sheet stored in the long sheet feeding cassette, accords with the print size designated by the print job,
the controller executes the printing operation, using the recording sheet stored in the long sheet feeding cassette.
